(19) United States
(12) Patent Application Publication
(10) Pub. No.: US 2005/0036004 A1
(43) Pub. Date: Feb. 17, 2005

(54) Methods and systems for conditioning slotted substrates

(76) Inventors: Barbara Horn, Eugene, OR (US); Keith Kirby, Albany, OR (US); Sam Holmes, Corvallis, OR (US); Mehrgan Khavari, Corvallis, OR (US); Rio Rivas, Corvallis, OR (US); Gerald G. Trunk, Monmouth, OR (US); Deanna J. Bergstrom, Corvallis, OR (US); Chon Pham, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/640,067

(22) Filed: Aug. 13, 2003

(51) Int. Cl. B41J 2/05

(52) U.S. Cl. 347/65; 29/890.1

(57) ABSTRACT

The described embodiments relate to slotted substrates. One exemplary method removes substrate material from a substrate to form a fluid-handling slot through the substrate. This particular method also mechanically conditions the substrate proximate the fluid-handling slot, at least in part, to remove debris created by the removing.

### BACKGROUND

The market for electronic devices continually demands increased performance at decreased costs. In order to meet these requirements the components which comprise various electronic devices must be made ever more efficiently and to closer tolerances.

One type of electronic device comprises a fluid ejecting device. Many fluid ejecting devices employ slotted substrates which can be formed utilizing various suitable substrate removal techniques. Many of the substrate removal techniques can inadvertently create debris on the slotted substrate and/or create regions of substrate material prone to cracking.

### BRIEF DESCRIPTION OF THE DRAWINGS

The same components are used throughout the drawings to reference like features and components wherever feasible. Alphabetic suffixes are utilized to designate different embodiments.

FIG. 1 illustrates a front elevational view of a diagrammatic representation of an exemplary printer in accordance with one exemplary embodiment.

FIG. 2 illustrates a perspective view of a diagrammatic representation of a print cartridge suitable for use in the exemplary printer shown in FIG. 1 in accordance with one exemplary embodiment.

FIG. 3 illustrates a diagrammatic representation of a side-sectional view a portion of the print cartridge shown in FIG. 2 in accordance with one exemplary embodiment.

FIGS. 4a-4h illustrate diagrammatic representations of process steps for conditioning an exemplary slotted substrate in accordance with one embodiment.

FIGS. 5a-5c illustrate diagrammatic representations of process steps for forming an exemplary slotted substrate in accordance with one embodiment

FIGS. 5d-5g illustrate diagrammatic representations of cross-sectional views of exemplary mechanical conditioning structures in accordance with various suitable embodiments.

FIGS. 6-6b illustrate diagrammatic representations of process steps for conditioning an exemplary slotted substrate in accordance with one exemplary embodiment.

### DETAILED DESCRIPTION OF THE PREFERRED EMBODIMENTS

Overview

The embodiments described below pertain to methods and systems for conditioning a slotted substrate. Slots can be formed in a substrate utilizing one or more production techniques for selective removal of substrate material. Suitable production techniques include, among others, etching, laser machining, abrasive jet machining, sawing and/or any combination thereof. At some point during the slot formation process and/or subsequently to slot formation, the substrate can be conditioned. In some embodiments, such conditioning can remove debris from the slotted substrates. Debris can comprise various materials such as processed substrate material and/or byproducts of processed substrate material which remains on the substrate from the slot formation process.

Slotted substrates can be incorporated into ink jet print cartridges and/or various micro electro mechanical systems (MEMS) devices, among other uses. The various components described below may not be illustrated accurately as far as their size is concerned. Rather, the included figures are intended as diagrammatic representations to illustrate to the reader various inventive principles that are described herein.

Exemplary Printing Device

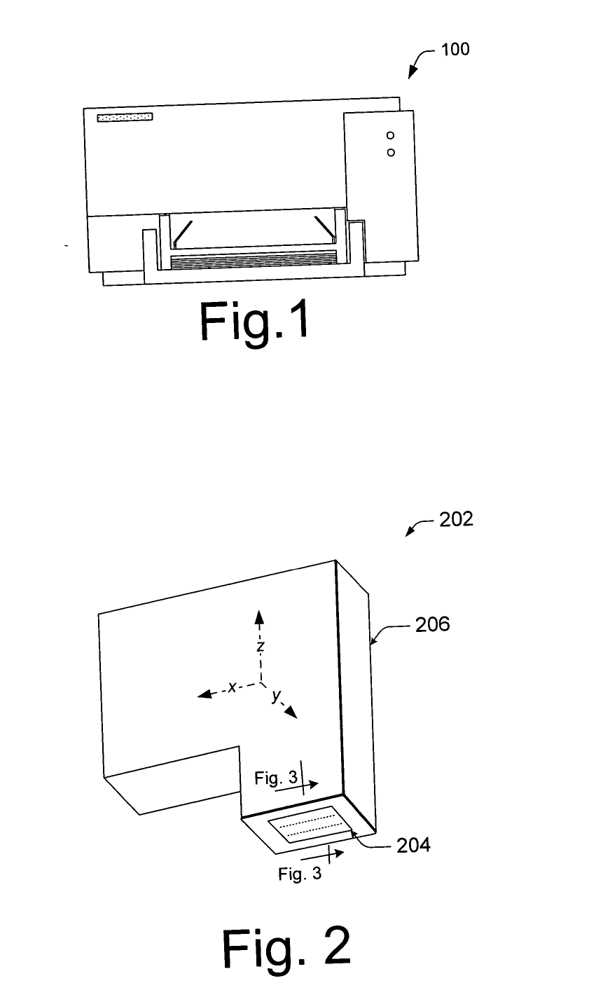

FIG. 1 shows a diagrammatic representation of an exemplary printing device that can utilize an exemplary print cartridge. In this embodiment, the printing device comprises a printer 100. The printer shown here is embodied in the form of an inkjet printer. The printer 100 can be capable of printing in black-and-white and/or in black-and-white as well as color. The term “printing device” refers to any type of printing device and/or image forming device that employs slotted substrate(s) to achieve at least a portion of its functionality. Examples of such printing devices can include, but are not limited to, printers, facsimile machines, and photocopiers. In this exemplary printing device, the slotted substrates comprise a portion of a print head which is incorporated into a print cartridge, an example of which is described below.

Exemplary Products and Methods

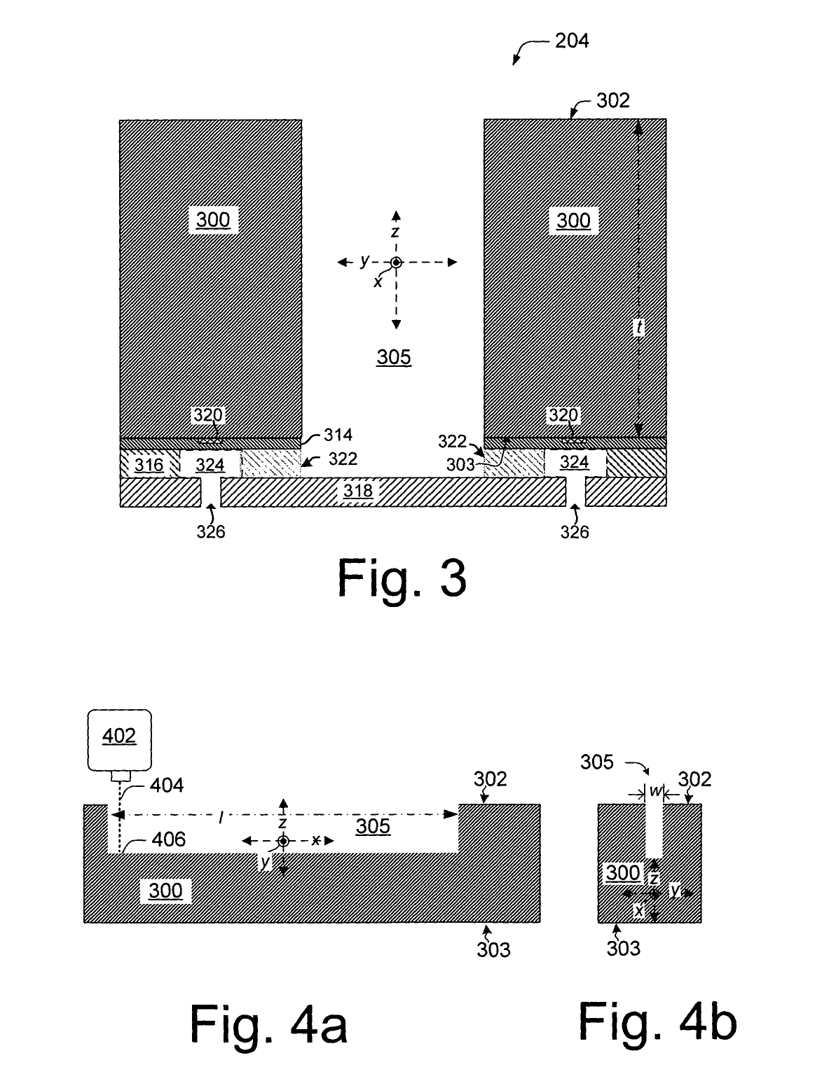

FIG. 2 shows a diagrammatic representation of an exemplary print cartridge 202 that can be utilized in an exemplary printing device. The print cartridge is comprised of a print head 204 and a cartridge body 206 that supports the print head. Though a single print head 204 is employed on this print cartridge 202 other exemplary configurations may employ multiple print heads on a single cartridge.

Print cartridge 202 is configured to have a self-contained fluid or ink supply within cartridge body 206. Other print cartridge configurations may alternatively or additionally be configured to receive fluid from an external supply. Other exemplary configurations will be recognized by those of skill in the art.

Reliability of print cartridge 202 is desirable for proper functioning of printer 100. Further, failure of print cartridges during manufacture increases production costs. Print cartridge failure can be brought about by a failure of the print cartridge components. Such component failure can be caused by cracking. As such, various embodiments described below can provide print heads with a reduced propensity to crack.

Reliability of print cartridges can also be affected by contaminants interfering with or occluding proper fluid (ink) flow. One source of contaminants is debris created during the slotting process. As such, various embodiments described below can provide print heads with a reduced incidence of failure due to inadequate ink flow.

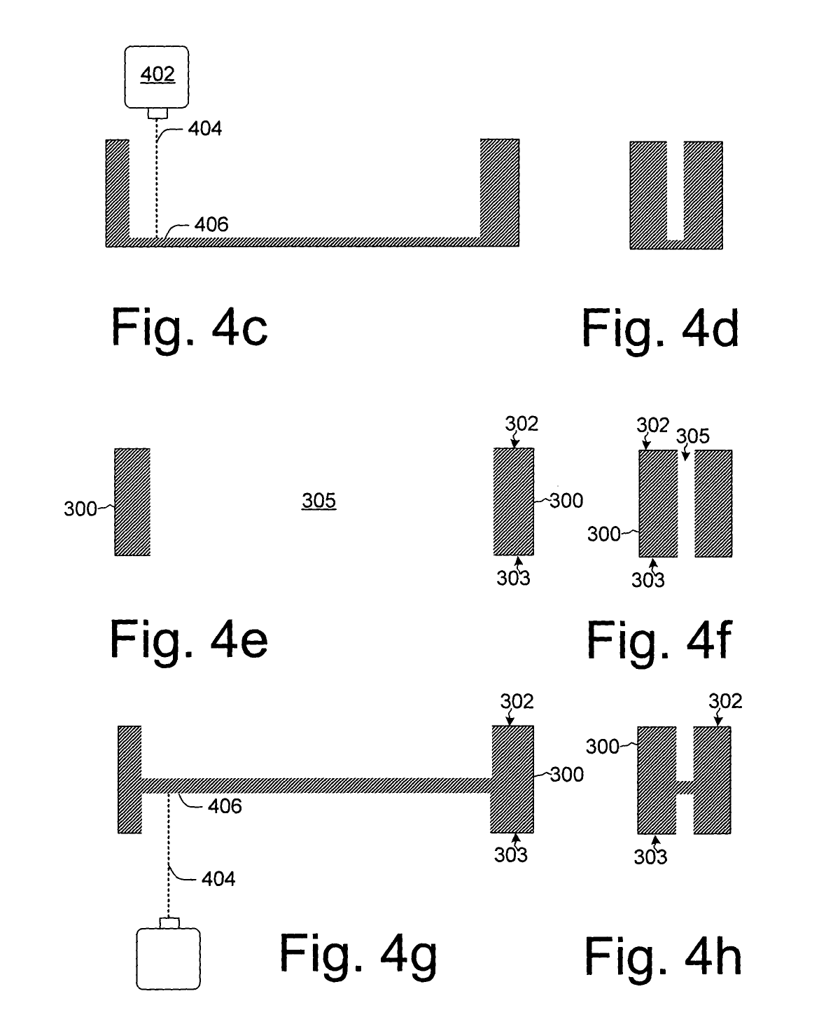

FIG. 3 shows a side-sectional diagrammatic representation of a portion of the exemplary print head 204, taken along line 3-3 in FIG. 2. The view of FIG. 3 is taken transverse a long axis x of a fluid-feed slot (described below), the long axis extending into and out of the plane of the page upon which FIG. 3 appears. Here, a substrate 300 has a thickness t which extends between a first substrate surface (“first surface”) 302 and a second substrate surface (“second surface”) 303. As will be described in more detail below, forces experienced by the substrate 300 during processing and operation can be concentrated in and around the substrate material proximate first surface 302. Some of the described embodiments can reduce stress concentrations within particular regions of the substrate material, notably, those in and around the substrate material proximate first surface 302.

Here, a slot 305 passes through substrate 300 between first and second surfaces 302, 303. As will be described in more detail below, some slot formation techniques can inadvertently produce debris on the substrate material defining slot 305 and/or on the first and second surfaces 302, 303. Such debris can be carried by fluid into the finished print head and cause diminished performance. Some of the described embodiments can remove such debris.

In this particular embodiment, substrate 300 comprises silicon which can be either doped or undoped. Other suitable substrate materials can include, but are not limited to, gallium arsenide, gallium phosphide, indium phosphide, or other crystalline material suitable for supporting overlying layers.

Substrate thicknesses (in the z-direction in FIG. 3) can have any suitable dimensions that are appropriate for substrates' intended applications. In some embodiments, substrate thicknesses taken relative to the z-direction can range from less than 100 microns to more than 2000 microns. One exemplary embodiment can utilize a substrate that is approximately 675 microns thick. Though a single substrate is discussed herein, other suitable embodiments may comprise a substrate that has multiple components during assembly and/or in the finished product. For example, one such embodiment may employ a substrate having a first component and a second sacrificial component which is discarded at some point during processing.

In this particular embodiment, one or more thin-film layers 314 are positioned over substrate's second surface 303. In at least some embodiments, a barrier layer 316 and an orifice plate or orifice layer 318 are positioned over the thin-film layers 314.

In one embodiment, one or more thin-film layers 314 can comprise one or more conductive traces (not shown) and electrical components such as resistors 320. Individual resistors can be selectively controlled by a controller such as a processor, via the electrical traces. Thin-film layers 314 can in some embodiments also define, at least in part, a wall or surface of multiple fluid-feed passageways 322 through which fluid can pass. Thin-film layers 314 can comprise among others, a field or thermal oxide layer. Barrier layer 316 can define, at least in part, multiple firing chambers 324. In some embodiments, barrier layer 316 may, alone or in combination with thin-film layers 314, define fluid-feed passageways 322. Orifice layer 318 can define multiple firing nozzles 326. Individual firing nozzles can be respectively aligned with individual firing chambers 324.

Barrier layer 316 and orifice layer 318 can be formed in any suitable manner. In one particular implementation, both barrier layer 316 and orifice layer 318 comprise thick-film material, such as a photo-imagable polymer material. The photo-imagable polymer material can be applied in any suitable manner. For example, the material can be “spun-on” as will be recognized by the skilled artisan.

After being spun-on, barrier layer 316 can then be patterned to form, at least in part, desired features such as passageways and firing chambers, therein. In one embodiment, patterned areas of the barrier layer can be filled with a sacrificial material in what is commonly referred to as a ‘lost wax’ process. In this embodiment, orifice layer 318 can be comprised of the same material as the barrier layer and be formed over barrier layer 316. In one such example, orifice layer material is ‘spun-on’ over the barrier layer. Orifice layer 318 can then be patterned as desired to form nozzles 326 over respective chambers 324. The sacrificial material is then removed from the barrier layer's chambers 324 and passageways 322.

In another embodiment, barrier layer 316 comprises a thick-film, while the orifice layer 318 comprises an electroformed nickel or other suitable metal material. Alternatively the orifice layer can be a polymer, such as Kapton or Oriflex, with laser ablated nozzles. Other suitable embodiments may employ an orifice layer which performs the functions of both a barrier layer and an orifice layer.

In operation fluid, such as ink, can enter slot 305 from the cartridge body, shown FIG. 2. Fluid can then flow through individual passageways 322 into an individual chamber 324. Fluid can be ejected from the chamber when an electrical current is passed through an individual resistor 320. The electrical current can heat the resistor sufficiently to heat some of the fluid contained in the firing chamber to its boiling point so that it expands to eject a portion of the fluid from a respectively positioned nozzle 326. The ejected fluid can then be replaced by additional fluid from passageway 322.

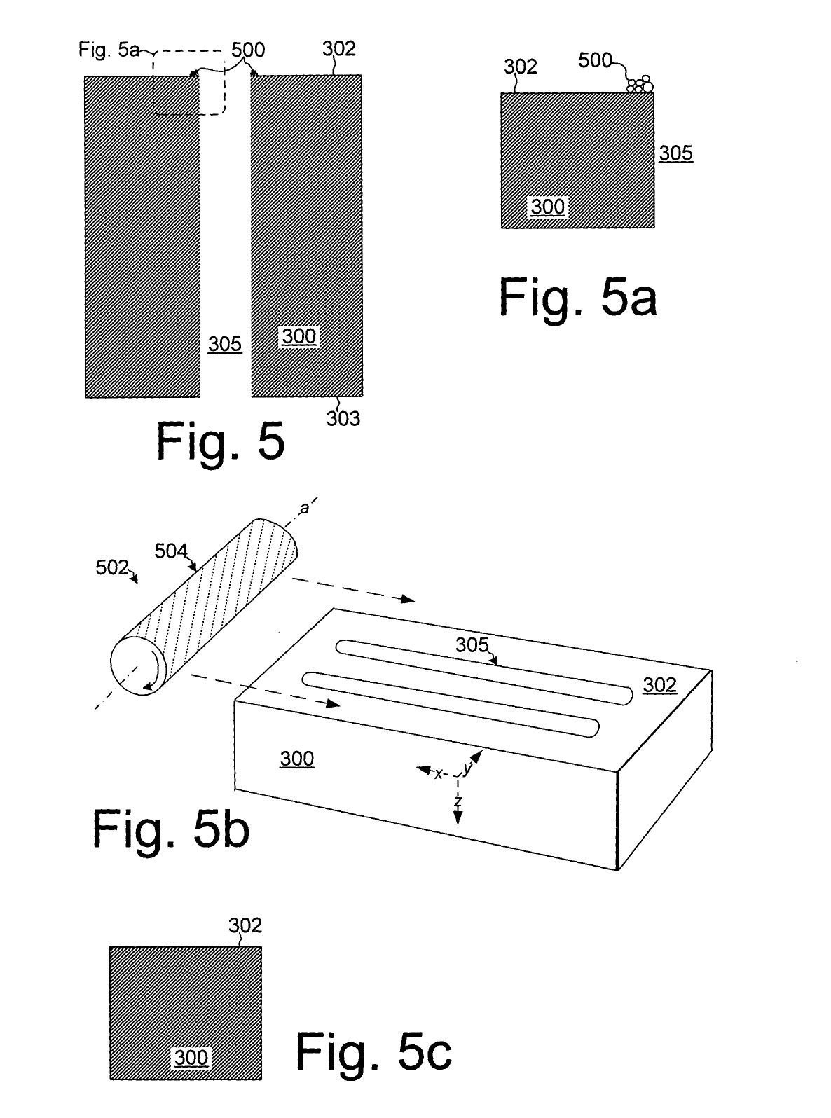

FIGS. 4a-4h show diagrammatic representations of process steps for forming an exemplary slotted substrate and constitute side-sectional views of substrate 300 as shown in FIG. 3. More specifically, FIGS. 4a-4h show an exemplary substrate removal process for forming slot 305 in substrate 300. As shown in FIGS. 4a-4d slot 305 is only partially formed through the substrate. FIGS. 4e-4f depict slot 305 extending through substrate 300 between first surface 302 and second surface 303. FIGS. 4a, 4c and 4e show views of substrate 300 into and out of the page within slot 305 and along the slot's long axis x. The views in FIGS. 4b, 4d and 4f are similar to the view shown in FIG. 3 and constitute views taken transverse a long axis x of slot 305.

Referring now to FIGS. 4a-4b, a laser machine 402 is positioned above substrate 300. As shown here, laser machine 402 emits a laser beam 404 directed at the substrate's first surface 302 to remove substrate material 406 to define a width w and a length l in substrate 300. Laser beam 404 removes substrate material 406 progressively toward second surface 303. For purposes of clarity, laser machine 402 and laser beam 404 are omitted from FIG. 4b.

FIGS. 4c-4d show views similar to FIGS. 4a and 4b respectively, where laser beam 404 has removed additional substrate material 406.

FIGS. 4e-4f show a slot 305 formed through substrate 300 from first surface 302 to second surface 303.

The slot forming process depicted in FIGS. 4a-4f is but one of many suitable processes. For example, etching, abrasive jet machining and sawing, among others, can also form slotted substrates. Abrasive jet machining directs abrasive particles such as silica toward the substrate in a controlled manner to selectively remove substrate material. Etching can comprise anisotropic etching and/or isotropic etching, or a combination thereof. In one suitable embodiment, etching can comprise alternating acts of etching and passivating to achieve a desired etch profile through the substrate. Sawing can utilize a circular saw to mechanically remove substrate material sufficient to form a slot. Alternatively to forming a slot utilizing a single process, suitable slots can be formed utilizing multiple processes. For example, substrate material can be removed by etching and then additional substrate material sufficient to form a desired slot can be removed by laser machining. The skilled artisan should recognize other suitable combinations.

A slot may also be formed by removing substrate material from both sides of the substrate. For example, FIGS. 4g-4h show substrate 300 as depicted in FIGS. 4a-4b where additional substrate material 406 is removed through second surface 303. In this example, the additional substrate material is removed via laser beam 404. The laser beam can remove further substrate material 406 to create slot 305 as depicted in FIGS. 4e-4f. Other suitable embodiments may utilize a different removal technique through second surface 303 than the removal technique utilized at first surface 302.

The slot formation process may create debris which can hinder integration of the slotted substrate into a functional fluid-ejecting device such as a print head. Such debris can comprise, at least in part, substrate material which was incompletely removed from and/or redeposited on the substrate. Debris can also comprise byproducts of the removal process, including but not limited to physical and/or chemical compounds formed between substrate material and material utilized in the substrate removal process. For example, debris may comprise a compound comprising, at least in part, a component supplied by an etchant, such a TMAH, and a component comprising substrate material.

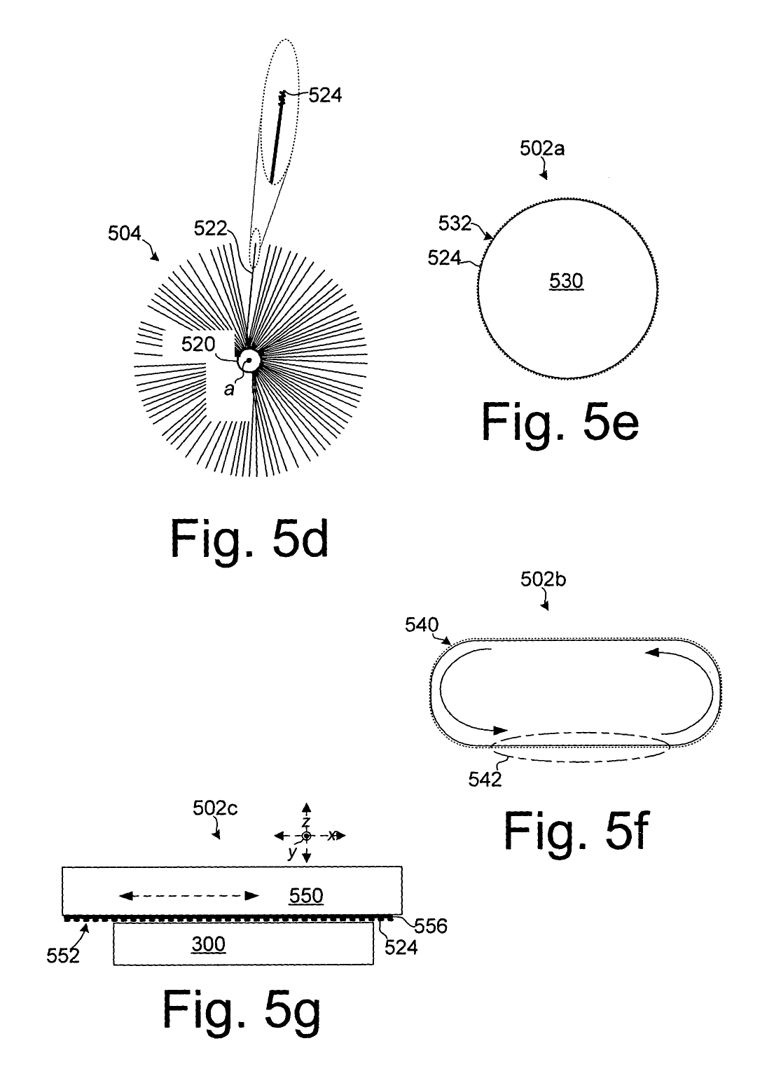

Referring now to FIG. 5 a diagrammatic representation shows an enlarged view of the slotted substrate 300 shown in FIG. 4f. FIG. 5a shows a further enlarged view of a portion of the substrate 300 indicated in FIG. 5. Debris 500, created at least in part by laser machining slot 305 into substrate 300, can be seen on first surface 302 proximate slot 305.

A slotted substrate can be conditioned to remove debris 500 before integrating the slotted substrate into a fluid-ejecting device. In some embodiments, such conditioning can comprise mechanically conditioning the substrate. Mechanically conditioning can comprise abrading the substrate with an abrasive material such as abrasive particles. In some embodiments, such abrading can comprise directing abrasive particles at the substrate. Some suitable embodiments can direct abrasive particles at the substrate by moving the abrasive material over the substrate. One such example can be seen in FIGS. 5b-5d. Other such examples are shown in FIGS. 5e, 5f and 5g.

FIG. 5b shows a diagrammatic representation of a perspective view of substrate 300. The substrate can be positioned on any suitable type of fixture, not shown. An abrasive structure 502 in the form of abrasive brush 504 is positioned proximate to the substrate. Abrasive brush 504 rotates about an axis of rotation a. Abrasive brush 504 can be moved over the substrate as it rotates about its axis to move the abrasive material along the substrate.

As shown in FIG. 5b, abrasive action can be created by rotating the brush so that the brush's outer surface is moving faster than the brush's axis of rotation is being moved along the substrate. In another example, the brush can be rotated in a direction opposite that shown in FIG. 5b while moving the brush over the substrate as indicated in a direction generally parallel to long axis x.

In this instance, abrasive brush 504 is oriented with long axis a generally orthogonal to long axis x. Abrasive brush 504 is positioned generally at the level of first surface 302 and moved generally parallel to long axis x along an entirety of first surface 302 while the brush is rotated. Other embodiments may move the abrasive brush in one or more different directions from those shown here. Alternatively or additionally, abrasive brush 504 may be moved over only a portion of first surface 302, such as a portion proximate slot 305. Other embodiments may alternatively or additionally move the brush over second surface 303 (shown FIG. 5). Alternatively or additionally, the brush may be positioned in a fixed location and rotated while substrate 300 and its surface 302 are moved relative to the brush to abrade the substrate surface. For purposes of clarity, a single substrate is being mechanically conditioned with abrasive brush 504. Many suitable embodiments may mechanically condition multiple substrates at once. For example, such mechanical conditioning may be conducted on a wafer comprising multiple slotted substrates before the wafer is diced into individual substrates.

In some embodiments, the conditioning process can be aided by utilizing coincident or subsequent processes to further remove debris. One such embodiment delivers a liquid such as water or ammonia to the substrate while mechanically conditioning the substrate. The liquid may aid in debris removal. Other embodiments may add other materials to the liquid to improve debris removal. Still other embodiments may utilize other suitable means such as applying a vacuum or pressurized air to aid the conditioning process.

FIG. 5c shows a diagrammatic representation of the portion of substrate 300 shown in FIG. 5a after mechanically conditioning the substrate. The debris 500 shown in FIG. 5a on first surface 302 was removed by conditioning the substrate.

FIG. 5d shows a diagrammatic representation of a cross-sectional view of abrasive brush 504 taken transverse long axis a. This exemplary abrasive brush comprises a central core 520. Multiple bristles 522 extend generally radially along a length away from the central core. Suitable bristles can be constructed from various suitable materials such as polyvinyl alcohol and nylon among others. In this embodiment, bristles 522 are generally flexible along their length. Such flexibility can allow the bristles to deform from the relatively axial configuration shown here when contacting a substrate. Other suitable configuration may utilize less flexible i.e. more rigid bristles or may utilize an abrasive structure that does not employ bristles. Such an example will be discussed below in relation to FIG. 5e.

In the embodiment shown in FIG. 5d, a distal portion of at least some of the bristles 522 have abrasive material 524 in the form of abrasive particles positioned thereon. In the embodiments described herein abrasive particles having a diameter of about 15-50 microns are utilized. Other suitable embodiments can employ other sizes of abrasive particles. This is but one suitable configuration. For example, another suitable configuration may utilize bristles formed from a material, such as steel or other metals, where the bristle material itself is sufficiently abrasive to condition a substrate without the addition of a material to provide abrasion.

In the present embodiment abrasive particles are positioned on the bristles with an adhesive. In this particular embodiment a water proof adhesive such as Gorilla Glue® is utilized. Other embodiments may utilize other suitable positioning means such as integrating abrasive particles into the bristle material during the manufacturing process.

FIG. 5e shows a diagrammatic representation of a cross-sectional view of an abrasive structure 502a similar to the view shown in FIG. 5d. In this example, the abrasive structure comprises an abrasive wheel 530 that is relatively rigid in that it tends to maintain its generally cylindrical cross-sectional shape when contacting a substrate. Abrasive wheel 530 has abrasive material 524 positioned on an outer distal surface 532 thereof for mechanically conditioning a substrate.

Though FIGS. 5d-5e show abrasive structures which are generally cylindrical and revolve around a central axis, this is but one suitable configuration. For example, FIG. 5f shows a diagrammatic representation of a cross-sectional view of an abrasive structure 502b that has an abrasive rotating surface 540. The abrasive rotating surface has two generally curved end regions and associated generally planar regions extending therebetween. One such generally planar region is indicated generally at 542. A substrate can be positioned proximate the generally planar region 542 for mechanically conditioning by the abrasive rotating surface 540.

In another example, FIG. 5g shows a diagrammatic representation of an abrasive structure 502c in the form of a planar abrasive structure 550 which has an abrasive surface 552 configured to mechanically condition a substrate. In this example, abrasive surface 552 has abrasive material 524 adhered to an underlying media 556. Planar abrasive structure 550 is configured to condition substrate 300 by moving the abrasive surface 552 along the x-axis, y-axis and/or a combination of the x- and y-axes while the abrasive surface is physically contacting substrate 300. Movement can be imparted through the abrasive structure and/or the fixture.

The above discussion relating to FIGS. 5-5g provides several examples of suitable means for mechanically conditioning a substrate by physically contacting the substrate with an abrasive material. Some embodiments can utilize a chemical process to enhance a mechanical conditioning process, otherwise known as chemical mechanical polishing.

In chemical mechanical polishing a liquid or other media can contribute to and/or accelerate the conditioning process so that the process is completed faster than if abrasive material alone was utilized. For example, in one such embodiment, a substrate surface comprising a portion of a wafer can be positioned against a polishing pad in the presence of an abrasive slurry. The wafer and/or polishing pad can then be moved relative to one another to condition, and in some embodiments planarize, the substrate surface. Such embodiments can be similar to the embodiment depicted in FIG. 5g where the pad is substituted for abrasive structure 550 and the abrasive slurry is substituted for abrasive surface 552. In some embodiments, the abrasive slurry can comprise at least an abrasive material and a liquid. The substrate and/or pad are moved relative to one another in various patterns which can include reciprocating, rotating and/or various combinations thereof.

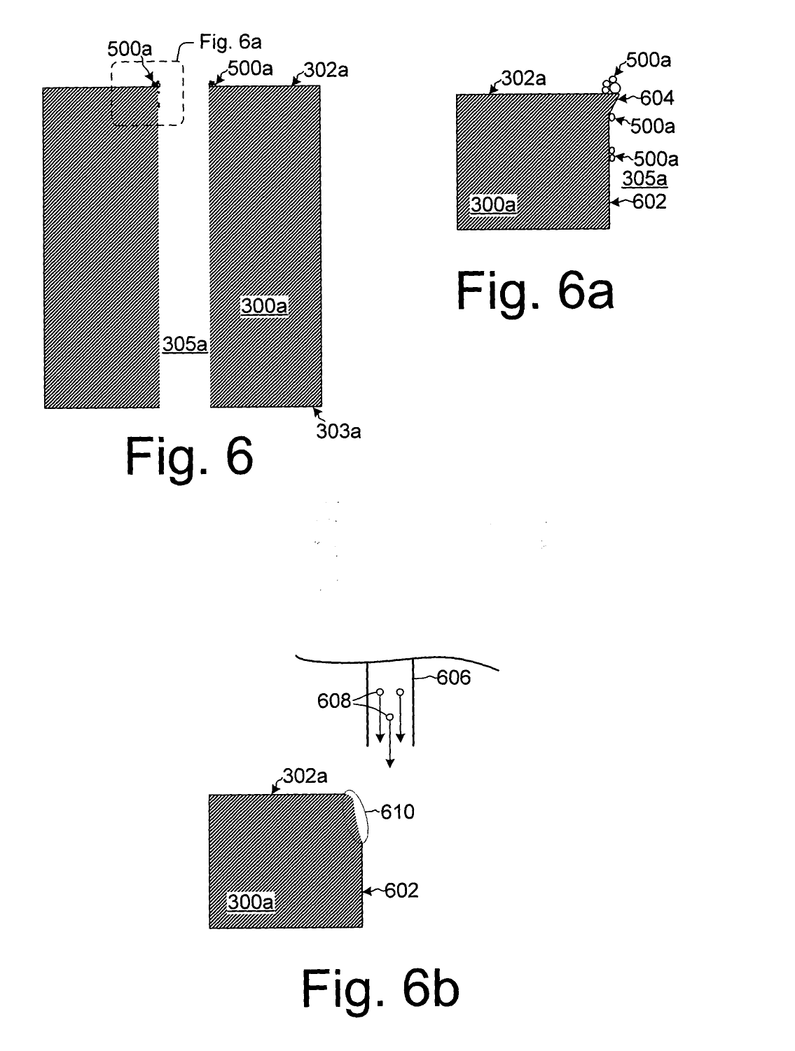

Another suitable embodiment for directing abrasive particles at a substrate is provided below in relation to FIGS. 6-6b. FIGS. 6-6a show diagrammatic representations of views similar to FIGS. 5 and 5a respectively. A slot 305a is formed in substrate 300a between first surface 302a and second surface 303a. In this particular embodiment, the slotting process produced debris 500a on substrate material defining a wall 602 of slot 305a and on first surface 302a. Further, in this embodiment, a relatively small region of substrate material 604 proximate first surface 302a extends away from the remainder of the substrate material and into the slot 305a. Substrate material 604 can act as a crack initiation site due to stress concentrations among other factors. Such crack initiation sites can result in failure of the slotted substrate during processing to form a fluid ejecting device and/or during the functional life of the fluid ejecting device.

FIG. 6b shows an exemplary process step for mechanically conditioning substrate 300a. Here, an abrasive jet machine nozzle 606 can project abrasive material such as abrasive particles 608 at the slotted substrate 300a. Abrasive particles 608 can abrade the debris 500a shown in FIGS. 6-6a from substrate 300a. Further, in some embodiments, the abrasive particles 608 can remove the projecting substrate material 604 shown in FIG. 6a and create a more contoured slot profile. An example of which is indicated generally in FIG. 6b, where a portion 610 of wall 602 is now generally curvilinear and contours into first surface 302a. Such a configuration can have a reduced propensity to crack.

Abrasive jet machine nozzle 606 propels abrasive particles 608 at the substrate via pressurized fluid carrying the particles. The fluid imparts motion to the abrasive particles. The fluid may also contribute to the conditioning process by carrying debris away from the substrate 300a. In this particular embodiment the fluid comprises air. Other gases can also be utilized in various embodiments to deliver the abrasive particles 608. Other embodiments can utilize a liquid to propel the abrasive particles toward the substrate. In one such embodiment, the liquid can comprise water. In some embodiments, the liquid may also comprise a component which reacts with the substrate. In one such example, a TMAH and water solution may be utilized with the abrasive particles.

Previously, abrasive jet machining has been used to form slots in a substrate. Some of the exemplary embodiments can utilize an abrasive jet machining process primarily to mechanically condition a substrate and not primarily to form a slot in the substrate. In one such example, abrasive particles can be directed at the substrate for a relatively short period of time. In some embodiments, a relatively short time period can be at least an order of magnitude less than a time period utilized when abrasive jet machining is utilized to form a slot in a substrate. For example, an abrasive jet machining process in the range of 3-8 seconds may be utilized to form a slot in a substrate, whereas mechanical conditioning may comprise 0.05 to 0.2 seconds in some embodiments. Projecting abrasive particles for such a relatively short time period is one suitable process for using abrasive jet machining primarily to condition the substrate and not primarily to form slots in the substrate.

### CONCLUSION

The described embodiments can condition a slotted substrate. Slots can be formed in a substrate utilizing one or more production techniques for selective removal of substrate material. At some point during the slot formation process and/or subsequently to slot formation, the substrate can be conditioned. In some embodiments, such conditioning can comprise mechanically conditioning to remove debris from the slotted substrates.

Although specific structural features and methodological steps are described, it is to be understood that the inventive concepts defined in the appended claims are not necessarily limited to the specific features or steps described. Rather, the specific features and steps are disclosed as forms of implementation of the inventive concepts.

1. A method comprising:
removing substrate material from a substrate to form a fluid-handling slot through the substrate; and,
mechanically conditioning the substrate proximate the fluid-handling slot, at least in part, to remove debris created by the removing.

2. The method of claim 1, wherein said act of removing comprises one or more of: laser machining, abrasive jet machining, and etching.

3. The method of claim 1, wherein said act of mechanically conditioning comprises abrading a first substrate surface with an abrasive material.

4. The method of claim 3, wherein said act of abrading comprises physically contacting the first substrate surface with an abrasive material and moving the abrasive material along the first substrate surface.

5. The method of claim 3, wherein said act of abrading comprises projecting the abrasive material at the first substrate surface.

6. A print cartridge formed in accordance with the method of claim 1.

7. A method comprising:
removing substrate material to form a fluid-handling slot extending between a first substrate surface and a second substrate surface; and,
mechanically conditioning at least one of the first and second substrate surfaces with a rotating abrasive brush.

8. The method of claim 7, wherein said act of removing substrate material comprises laser machining.

9. The method of claim 7 further comprising directing a fluid at the substrate during at least a portion of time during said act of mechanically conditioning.

10. The method of claim 7, wherein said act of removing substrate material comprises laser machining by directing a laser beam in a direction that is generally orthogonal to the first substrate surface and wherein said laser beam passes through the first substrate surface before reaching the second substrate surface and wherein said act of mechanically conditioning at least one of the first and second substrate surfaces comprises mechanically conditioning the first substrate surface.

11. The method of claim 7, wherein said act of removing substrate material forms multiple fluid-handling slots on a wafer and wherein said act of mechanically conditioning occurs prior to dicing the wafer into individual substrates.

12. The method of claim 7, wherein said act of mechanically conditioning comprises mechanically conditioning an entirety of the at least one of the first and second substrate surfaces.

13. The method of claim 7, wherein said act of mechanically conditioning comprises rotating the abrasive brush about an axis of rotation which is generally orthogonal to a long axis of the fluid-handling slot, and moving the abrasive brush in a direction generally parallel the long axis of the fluid-handling slot.

14. The method of claim 7, wherein said act of mechanically conditioning comprises rotating the abrasive brush about an axis of rotation which is generally orthogonal to a long axis of the fluid-handling slot, and moving a wafer comprising the first and second substrate surfaces in a direction generally parallel the long axis of the fluid-handling slot.

15. A print cartridge formed in accordance with the method of claim 7.

16. A method comprising:
removing substrate material to form a fluid-handling slot extending between a first substrate surface and a second substrate surface; and,
projecting abrasive particles toward the first substrate surface primarily to condition the substrate proximate to the fluid-handling slot and not primarily to form the fluid-handling slot.

17. The method of claim 16, wherein said act of removing comprises removing substrate material utilizing at least two different removal techniques to form the fluid-handling slot.

18. The method of claim 16, wherein said act of removing comprises first removing substrate material through the first substrate surface and subsequently removing substrate material through the second substrate surface.

19. The method of claim 16, wherein said act of projecting removes debris created by said act of removing.

20. The method of claim 16, wherein said act of projecting comprises directing a pressurized fluid carrying the abrasive particles toward the first substrate surface.

21. A print cartridge formed in accordance with the method of claim 16.

22. A method of processing a semiconductor substrate comprising:
forming a fluid-handling slot through a substrate, at least in part, by laser machining the substrate; and,
abrading the substrate, at least in part, to remove debris remaining from the laser machining process.

23. The method of claim 22, wherein said act of abrading comprises directing abrasive particles at the substrate.

24. The method of claim 22, wherein said act of abrading comprises contouring at least a portion of a wall defining the fluid-handling slot.

25. The method of claim 22, wherein said act of abrading comprises physically contacting the substrate with an abrasive structure having abrasive particles positioned thereon.

26. A print cartridge formed in accordance with the method of claim 22.

27. A system comprising:
means for removing substrate material from a substrate to form a fluid-handling slot between a first substrate surface and a second substrate surface; and,
means for mechanically conditioning the substrate proximate the fluid-handling slot, at least in part, to remove debris created by the removing.

28. A fluid ejecting device comprising:
a substrate comprising at least a first substrate surface and a second substrate surface, a fluid-handling slot extending through the substrate between the first substrate surface and the second substrate surface; and,
an orifice layer positioned over the first substrate surface, the orifice layer having multiple firing nozzles formed therein, at least some of the nozzles being in fluid flowing relation with the fluid-handling slot, wherein at least one of the first substrate surface and the second substrate surface being mechanically conditioned prior to the orifice layer being positioned over the first substrate surface, at least in part, to reduce the incidence of debris occluding ink flow through individual nozzles.

29. A print cartridge comprising, at least in part, the fluid ejecting device of claim 28.
